(19) United States
(12) Patent Application Publication
(10) Pub. No.: US 2010/0169136 A1
(43) Pub. Date: Jul. 1, 2010

(54) INFORMATION AGGREGATION FOR SOCIAL NETWORKS

(76) Inventors: NANCY ELLEN KHO, Belmont, MA (US); REBECCA HUGHES, Somerville, MA (US); JAMIE LIU, Boston, MA (US); JUDY J. PIPER, Woburn, MA (US); MARY ELLEN ZURKO, Groton, MA (US)

Correspondence Address: HOLLAND & KNIGHT, 10 ST. JAMES AVENUE, BOSTON, MA, 02116-3889, US

(21) Appl. No.: 12/347,485

(22) Filed: Dec. 31, 2008

(51) Int. Cl. G06Q 10/00

(52) U.S. Cl. 705/7

(57) ABSTRACT

A dynamically developed social networking group is defined within a collaborative platform. Information regarding one or more attributes of one or more members of the group is collected. Anonymized statistical data regarding the group is provided, based upon, at least in part, the information regarding one or more attributes of one or more members of the group.

### TECHNICAL FIELD

The present disclosure generally relates to social networks, and more particularly relates to anonymized information regarding members of a social network.

### BACKGROUND

Many types of information about employees are collected and analyzed by companies and managers. The collected information may be used, for example, for planning pay structures, expenditures associated with expansion of a company, determining employee satisfaction, etc. Some of this information may be considered private and should not be accessible to some parties. Further, sensitive or private information may be difficult to collect, for example, because of a reluctance by employees to give out such information. However, it may be helpful for a manager to be able to access at least the raw statistics of the information to allow better management of a department, to plan for expansion or redirection of a company, or the like.

### SUMMARY

According to a first implementation a computer program product includes a computer readable medium having a plurality of instructions stored on it. When executed by a processor, the instructions cause the processor to perform operations including defining a dynamically developed social networking group within a collaborative platform. Information regarding one or more attributes of one or more members of the group is collected. Anonymized statistical data regarding the group is provided, based upon, at least in part, the information regarding one or more attributes of one or more members of the group.

One or more of the following feature may be included. The dynamically developed social network group may be based upon, at least in part, one or more formal organization charts. The dynamically developed social networking group may be based upon, at least in part, one or more attributes of a plurality of members of the group.

The instructions for collecting information may further include instructions for associating a confidentiality sensitivity level associated with the information regarding one or more attributes of the members of the group. The instructions for associating a confidentiality sensitivity level may include instructions for associating the confidentiality sensitivity level based upon, at least in part, a user input. The instructions for associating a confidentiality sensitivity level may include instructions for associating the confidentiality sensitivity level based upon, at least in part, one or more predetermined schema.

The instructions for providing anonymized statistical data based upon the information may include instructions for providing anonymized statistical data consistent with the confidentiality sensitivity level associated with the information.

According to another implementation, a computing system includes a processor and a memory module. A first software module is executable by the processor and the memory module. The first software module is configured to define a dynamically developed social networking group within a collaborative platform. A second software module is executable by the processor and the memory module. The second software module is configured to collect information regarding one or more attributes of one or more members of the group. A third software module is executable by the processor and the memory module. The third software module is configured to provide anonymized statistical data regarding the group, based upon, at least in part, the information regarding one or more attributes of one or more members of the group.

One or more of the following features may be included. The dynamically developed social network group may be based upon, at least in part, one or more formal organization charts. The dynamically developed social networking group may be based upon, at least in part, one or more attributes of a plurality of members of the group.

The second software module, configured to collect information, may be further configured to associate a confidentiality sensitivity level associated with the information regarding one or more attributes of the members of the group. The second software module, configured to associate a confidentiality sensitivity level, may be further configured to associate the confidentiality sensitivity level based upon, at least in part, a user input. The second software module, configured to associate a confidentiality sensitivity level, may be further configured to associate the confidentiality sensitivity level based upon, at least in part, one or more predetermined schema.

The third software module, configured to provide anonymized statistical data based upon the information, may be configured to provide anonymized statistical data consistent with the confidentiality sensitivity level associated with the information.

According to yet another implementation, a computer implemented method includes defining a dynamically developed social networking group within a collaborative platform. Information is collected regarding one or more attributes of one or more members of the group. Anonymized statistical data regarding the group is provided, based upon, at least in part, the information regarding one or more attributes of one or more members of the group.

One or more of the following features may be included. The dynamically developed social network group may be based upon, at least in part, one or more formal organization charts. The dynamically developed social networking group may be based upon, at least in part, one or more attributes of a plurality of members of the group.

Collecting information may further include associating a confidentiality sensitivity level associated with the information regarding one or more attributes of the members of the group. Associating a confidentiality sensitivity level may include associating the confidentiality sensitivity level based upon, at least in part, a user input. Associating a confidentiality sensitivity level may include associating the confidentiality sensitivity level based upon, at least in part, one or more predetermined schema.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an information aggregation process and a collaborative system coupled to a distributed computing network.

FIG. 2 is a flowchart of a process performed by the information aggregation process of FIG. 1.

FIG. 3 diagrammatically depicts a profile questionnaire that may be generated by one or more of the information aggregation process and the collaborative system of FIG. 1.

FIG. 4 diagrammatically depicts attribute intersections of several users of the collaborative system of FIG. 1.

FIG. 5 diagrammatically depicts a survey that may be generated by one or more of the information aggregation process and the collaborative system of FIG. 1.

FIG. 6 diagrammatically depicts a statistical information display that may be generated by one or more of the information aggregation process and the collaborative system of FIG. 1.

### DETAILED DESCRIPTION OF EXEMPLARY EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

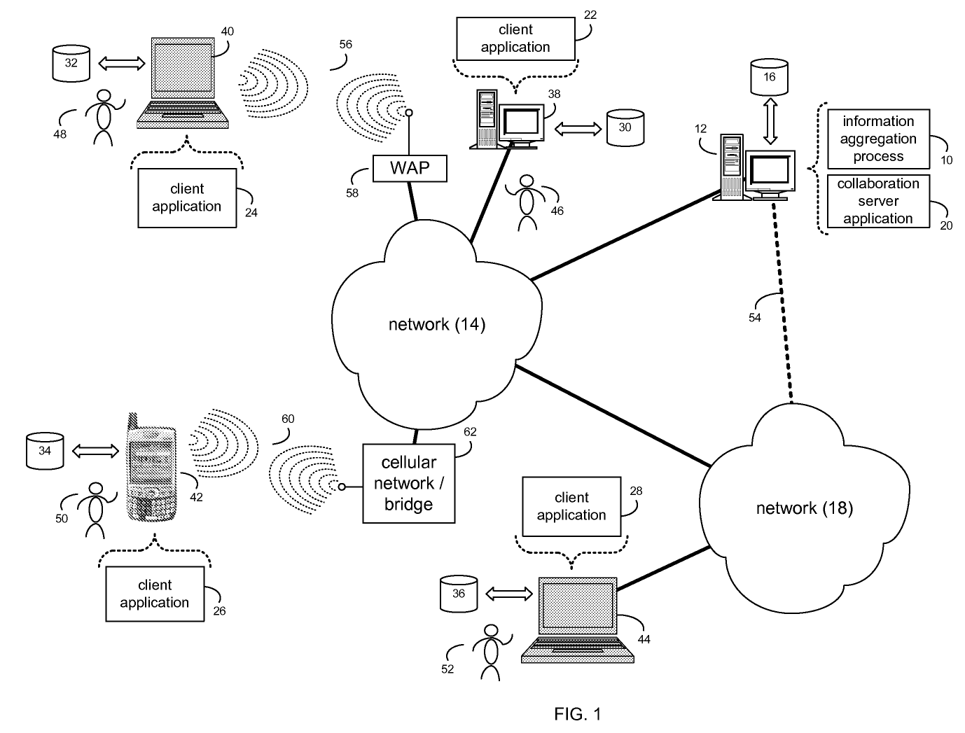

Referring to FIG. 1, there is shown information aggregation process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

As will be discussed below in greater detail, information aggregation process 10 may define a dynamically developed social networking group within a collaborative platform. Information regarding one or more attributes of one or more members of the group may be collected. Anonymized statistical data regarding the group may be reported, based upon, at least in part, the information regarding one or more attributes of one or more members of the group.

The instruction sets and subroutines of information aggregation process 10, which may be configured as one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive; a tape drive; an optical drive; a RAID array; a random access memory (RAM); and a read-only memory (ROM).

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute collaboration server application 20, an example of collaborative server application 20 may include, but is not limited to, the Apollo software as a service (SaaS) collaboration platform called “Bluehouse” now, from IBM, currently at bluehouse.lotus.com. Collaboration server application 20 may provide information to be posted (e.g., to user accessible profile pages), information to be exchanged (via electronic communications systems such as email, instant messaging, forum posts, and the like), etc., via client applications 22, 24, 26, 28, examples of which may include but are not limited to web browsers (e.g., Microsoft Internet Explorer®, Apple® Safari®, etc.) or a custom interface application. (Internet Explorer is a registered trademark of Microsoft Corporation in the United States, other countries, or both, and Apple and Safari are registered trademarks of Apple Inc. in the United States, other countries, or both). Information aggregation process 10 may be a stand alone application that interfaces with collaboration server application 20 or an applet/application that is executed within collaboration server application 20.

The instruction sets and subroutines of collaboration server application 20, which may be configured as one or more software modules, and which may be stored on storage device 16 coupled to server computer 12 may be executed by one or more processors (not shown) and one or more memory modules (not shown) incorporated into server computer 12.

The instruction sets and subroutines of client applications 22, 24, 26, 28, which may be configured as one or more software modules, and which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives; tape drives; optical drives; RAID arrays; random access memories (RAM); read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may, for example, access personal profile pages relative to a social network, may exchange information with other users of the social network, and the like.

Users 46, 48, 50, 52 may access collaboration server application 20 directly through the device on which the client application (e.g., client applications 22, 24, 26, 28) is executed, namely client electronic devices 38, 40, 42, 44, for example. Users 46, 48, 50, 52 may access collaboration server application 20 directly through network 14 or through secondary network 18. Further, server computer 12 (i.e., the computer that executes collaboration server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft® Windows®, Microsoft Windows CE®, Red Hat® Linux®, or a custom operating system (Windows CE is a registered trademark of Microsoft Corporation in the United States, other countries, or both).

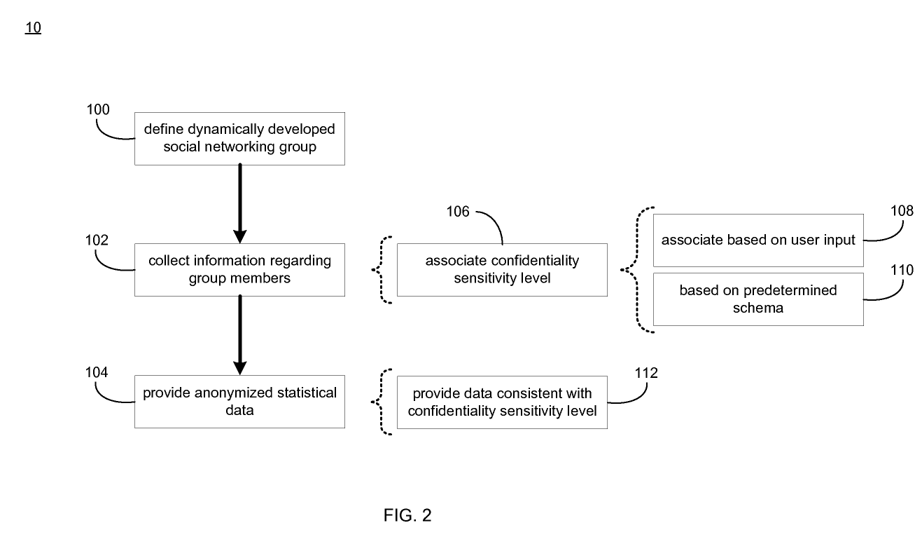

Referring also to FIG. 2, information aggregation process 10 may define 100 a dynamically developed social networking group within a collaborative platform. Information regarding one or more attributes of one or more members of the group may be collected 102. Further, information aggregation process 10 may provide 104 anonymized statistical data regarding the group, based upon, at least in part, the information regarding one or more attributes of one or more members of the group.

The dynamically developed social networking group may be based upon, at least in part, one or more attribute of each of the plurality of members of the group. For example, the dynamically developed social networking group may include a plurality of members that may be connected based upon, at least in part a common place of employment; a common, or similar, job, a common geographic location, or other attribute that may, for example, be a point of professional and/or personal intersection or commonality between the various members of the social networking group. As such, each of the members of any given social networking group may also be members of various other social networking groups, e.g., based upon one or more intersecting (e.g., common or related) attributes with the members of the other social networking groups.

In an embodiment in which the members of the collaborative platform may include members from a single company, the dynamically developed social networking group may be based upon, at least in part one or more formal organization charts. The one or more formal organization chart (e.g., which may be embodied in a corporate directory, such as a corporate LDAP directory, not shown) may include information regarding corporate departments, sub-departments (e.g., teams), management chains, and the like. Further, the dynamically developed social networking group may be based upon, at least in part, any statement of relationships between individuals. Such statements of relationships may be derived from the individuals themselves, from the collaborative platform, or from another trusted source, and may be based upon an organization chart, declared relationships of the users (e.g., friendships, business relationships, and the like), etc.

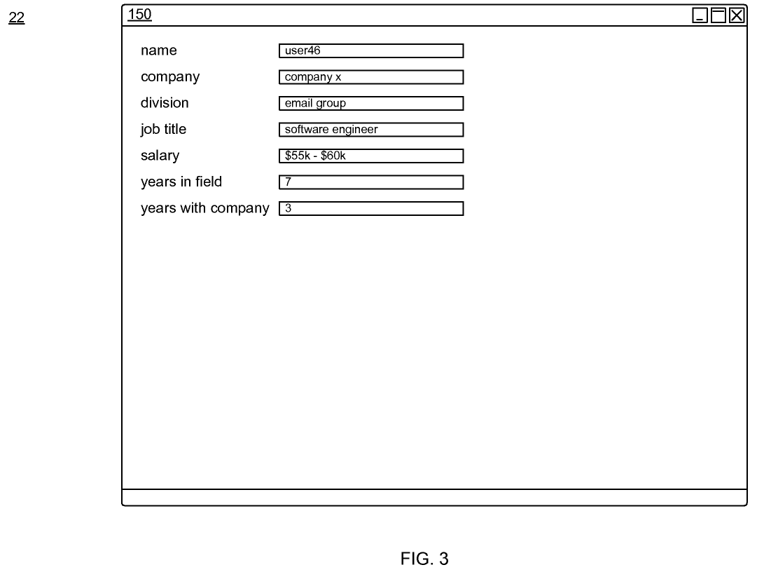

Additionally/alternatively, the dynamically developed social network group may be based upon, at least in part, one or more attributes of a plurality of members of the group. For example, information aggregation process 10 (alone or in conjunction with collaboration server application 20) may collect 102 information regarding one or more attributes of one or more members of the social networking group (e.g., including collecting 102 information prior to a user becoming a member of a specific social networking group). Referring also to FIG. 3, upon joining the collaborative environment (e.g., which may be provided, at least in part, by collaboration server application 20) a user (e.g., user 46) may provide a personal profile, e.g., by filling out profile questionnaire 150 via client application 22 (e.g., using one or more of a keyboard and a pointing device; not shown) including one or more data fields (e.g., which may represent user/member attributes). While profile questionnaire 150 is shown only including seven data fields (namely, “name,” “company,” “division,” “job title,” “salary,” “years in field,” and “years with company”), this is intended for illustrative purposes only, and should not be construed as a limitation of the present disclosure. The number and nature of data fields included within profile questionnaire 150 may vary according to design criteria and user preference.

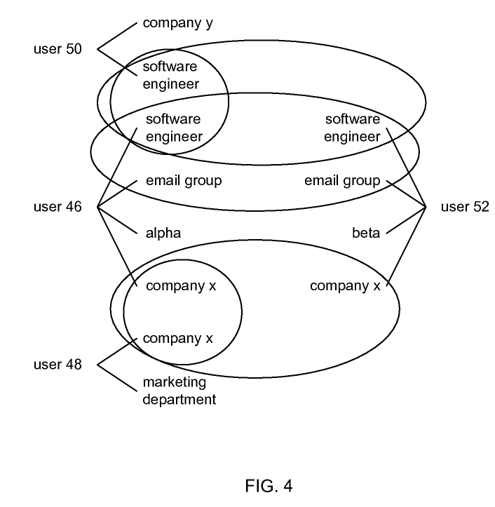

Based upon, at least in part, one or more formal organization charts, one or more statements of relationships between individuals, and/or one or more attributes of a user (e.g., which may be collected by information aggregation process 10, at least in part via profile questionnaire 150), information aggregation process (alone or in conjunction with collaboration server application 20) may define 100 one or more dynamically developed social networking groups within a collaborative environment (e.g., which may be provided, at least in part, by information aggregation process 10 and/or collaboration server application 20). Referring also to FIG. 4, assume that user 46 is a mid-level software engineer with company x. Further assume that user 48 is in the marketing department of company x. Accordingly, user 46 and user 48 may belong to a common social networking group (e.g., “company x” group) based upon their common employment by company x. Further assume that user 50 is a software engineer with company y. User 46 and user 50 may be in a common social networking group (e.g., “software” group) based upon user 46 and user 50 both being software engineers. Further, assume that user 52 is also a software engineer with company x, and that both user 46 and user 52 belong to the email development group of company x. Accordingly, user 52 may belong to the “software” group along with user 46 and user 50. Additionally, user 52 may belong to the “company x” group along with user 46 and user 48. Further, both user 46 and user 52 may belong to an “email” group, which may be a sub-group of the “software” group. Of course, each of the social networking groups may include additional members, and further each of user 46, user 48, and user 50 may be members of various additional social networking groups based upon, at least in part, other attributes (not shown)

Defining 100 the dynamically developed social networking groups may include mapping one or more attributes of one or more users. For example, job titles for equivalent positions may vary between different companies. For example, the job title “software engineer” may be utilized by company x. An equivalent position at company y may be “software developer.” Information aggregation process 10 (alone or in conjunction with collaboration server application 20) may map the job title “software developer” to “software engineer” based upon, for example, a reference table (not shown), e.g., which may be stored on storage device 16 coupled to server computer 12.

As described above, various members of a given social networking group (e.g., the “software” group) may have a person to person link with the other members of the “software” group. The person to person link may be a link between the members on an individual basis. Additionally, the various members of the “software” group may have a person to group link. The person to group link may be a connection of an individual member of the “software” group to the “software” group as a whole.

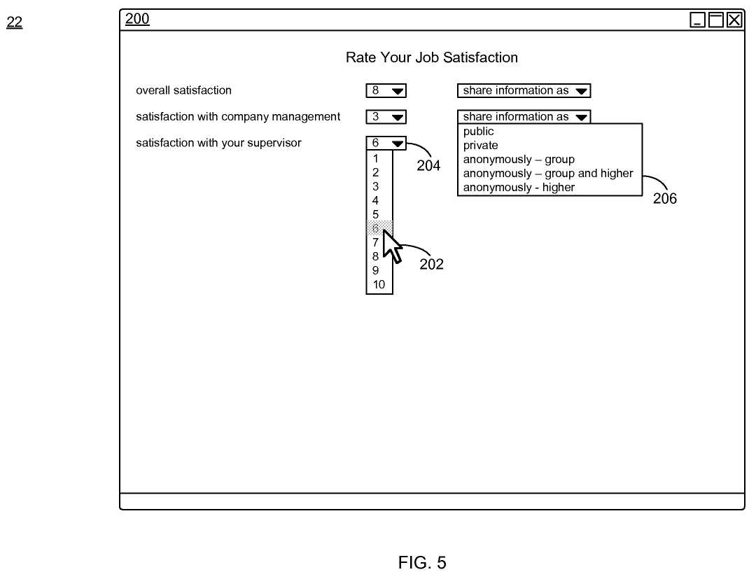

In addition to information collected 102 via the profile questionnaire (e.g., profile questionnaire 150), information aggregation process 10 (alone or in conjunction with collaboration server application 20) may collect 102 additional information regarding one or more attributes of one or more members of the group. For example, additional information may be collected through surveys, polls, or the like. For example, and referring also to FIG. 5, survey 200 may be provided to user 46 (e.g., via one or more of client application 22, collaboration server application 20, and information aggregation process 10), for example via a member profile page. An exemplary survey may pertain to job satisfaction of the various members of a group (e.g., the “software” group). For example, survey 200 may request that user 46 rank overall job satisfaction, satisfaction with company management, and satisfaction with the member's direct supervisor. However, the foregoing exemplary questions should not be construed as a limitation of the disclosure as the number, subject matter, etc., of questions in a survey or poll may vary according to user need and interest.

Continuing with the above-stated example, in survey 200 (e.g., which may be accessible via client application 22), user 46 may select, using onscreen pointer 202 (e.g., which may be controlled by a pointing device, such as a mouse; not shown), a numerical value from one or more pull-down menus (e.g., pull-down menu 204). Responses selected by user 46 may be collected 102 by information aggregation process 10, and, e.g., stored on storage device 16 coupled to server computer 12.

Collecting 102 information may further include associating 106 a confidentiality sensitivity level with the information regarding one or more attributes of the members of the group. The confidentiality sensitivity level may, for example, be indicative of how willing a member may be to publicly share the information. The confidentiality sensitivity level may be denoted in various manners (e.g., numerically, written expression, via icons, etc.). Generally, the confidentiality sensitivity levels may indicate that the information is public information that may be freely shared, private information that should not be shared, and information that may be anonymously shared (e.g., shared without attributing the information to a particular member). Further, anonymously shared information may be further classified, e.g., as information that may be anonymously shared to other members of the social networking group only, anonymously shared to members of the social networking group and to members of higher level groups, or anonymously shared to higher level groups only. It should be understood that the above confidentiality sensitivity levels are provided for the purpose of explanation only and should not be construed as a limitation of the present disclosure, as various additional/alternative classifications of the confidential nature of the information may be equally utilized.

Associating 106 a confidentiality sensitivity level may include associating 108 the confidentiality sensitivity level based upon, at least in part, a user input. For example, and with continued reference to FIG. 5, one or more question of survey 200 may include an associated pull-down menu (e.g., pull-down menu 206) that may include one or more levels of confidentiality sensitivity. User 46 may select, via onscreen pointer 202) a desired level of confidentiality sensitivity. Information aggregation process 10 may associate 108 the selected confidentiality sensitivity level with the information collected 102 via the corresponding question of survey 200.

Associating 106 a confidentiality sensitivity level may include associating 110 the confidentiality sensitivity level based upon, at least in part, one or more predetermined schema. That is, a predetermined schema may be provided, e.g., which may systemically determine that certain information collected 102 by information aggregation process 10 may always be private, always be anonymously shared, etc. For example, in survey 200 a predetermined schema may dictate that the response to the question “satisfaction with your supervisor” may always have an associated 110 confidentiality sensitivity level of anonymously shareable. As such, no pull-down menu may be provided for selecting a confidentiality level associated with the members response.

While not shown, various confidentiality sensitivity levels may be associated 106 with various pieces of information collected 102 through profile questionnaire 150. In a manner similar to the above-description, confidentiality sensitivity levels may be associated 108 with various pieces of information collected 102 via profile questionnaire 150 based upon, at least in part, a user input (e.g., indicating a desired confidentiality sensitivity level). Further, and also in a manner similar to the above-description, confidentiality sensitivity levels may be associated 110 with various pieces of information collected via profile questionnaire 150 based upon, at least in part, one or more predetermined schema.

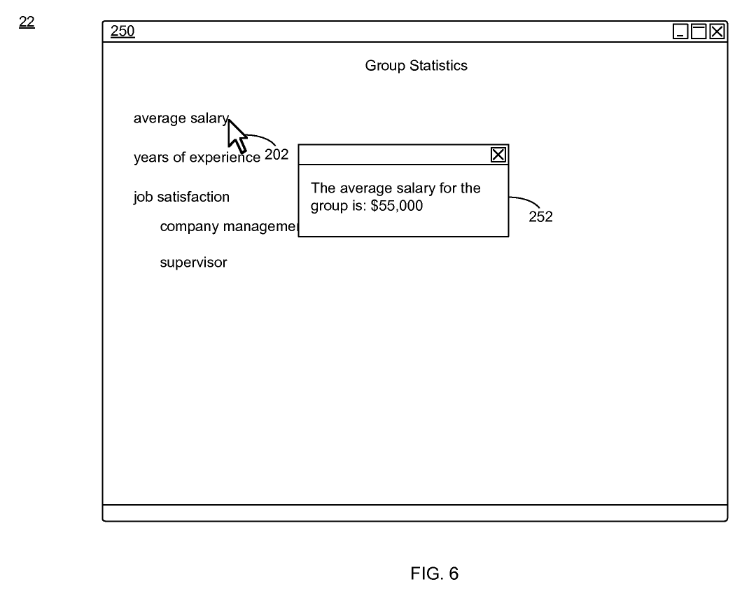

Anonymized statistical data may be provided 104, based upon, at least in part, the information regarding one or more attributes of one or more members of the social networking group. For example, information aggregation process 10 may provide 104 anonymized statistical data in response to specific request (e.g., which may be based upon user generated queries), as reports of pre-selected pieces of information, or the like. As such, information relating a specifically defined class of users (e.g., only those users within the “software” group) may be provided 104. For example, and referring also to FIG. 6, information aggregation process 10 (alone or in conjunction with collaboration server application 20) may provide a listing of available statistical information that may be accessed (e.g., via group statistics page 250). While group statistics page 250 is only shown including five options (namely, “average salary,” “years of experience,” and “job satisfaction” having sub-categories “company management,” and “supervisor”) this is for illustrative purposes only, and should not be construed as a limitation of the disclosure, as the number and nature of options included within group statistics page 250 may vary according to design criteria and user preference.

For example, and with continued reference to FIG. 6, group statistics page 250 may, for example, be accessible by a user (e.g., user 46) via a client application (e.g., client application 22). User 46 may obtain an average salary of the members of the “software” group by selecting, via onscreen pointer 202, the option “average salary” from within group statistics page 250. Selecting the option “average salary” from within group statistics page 250 may result in information aggregation process 10 (alone or in conjunction with one or more of collaboration server application 20 and client application 22) rendering pop-up window 252, e.g., which may include the average salary of the “software” group.

Providing 104 anonymized statistical data based upon the information may include providing 112 anonymized statistical data consistent with the confidentiality sensitivity level associated with the information. For example, anonymized statistical data may not be provided 104 based upon collected 102 information that has an associated 106 confidentiality sensitivity level of “private.” Similarly, anonymized statistical data having an associated 106 confidentiality sensitivity level of “share anonymously as group-level information only to those in my group” may not be provided 104 to a requesting user that is not a member of the group.

Further, access to the anonymized statistical data may be based upon, at least in part, one or more policies that may be established, e.g., by a system administrator, by a group moderator, or the like. For example, access to the information may be based upon, at least in part, a status of the requesting user (e.g., a manager may have access to particular pieces of group level information that may not be accessible to a member having a lower position). Additionally, a requesting user may only have access to a particular piece of group statistical information if the requesting user has submitted the information. Further, a given piece of statistical information may only be accessible if a threshold number of members have contributed the information (e.g., to prevent reverse-engineering of the data to determine who contributed information and/or to determine information pertaining to a particular member).

Consistent with the foregoing, based upon, at least in part, the confidentiality sensitivity levels associated 106 with the information, information aggregation process 10 may provide 104 the anonymized statistical data as one or more reports outside of the group. For example, a human resources manager of company c may be evaluating a current pay structure of software engineers of company c. As such, the human resources manager may request a report of average salary for software engineers. Information aggregation process 10 may provide 104 the average salary for a dynamically developed social networking group defined 100 based upon a member attribute “job title=software engineer.” As such, the human resource manager may obtain a useful statistic (i.e., average salary) based only upon individuals who are software engineers.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer program product comprising a computer readable medium having a plurality of instructions stored thereon, which, when executed by a processor, cause the processor to perform operations comprising:
defining a dynamically developed social networking group within a collaborative platform;
collecting information regarding one or more attributes of one or more members of the group; and
providing anonymized statistical data regarding the group, based upon, at least in part, the information regarding one or more attributes of one or more members of the group.

2. The computer program product of claim 1, wherein the dynamically developed social networking group is based upon, at least in part, one or more formal organization charts.

3. The computer program product of claim 1, wherein the dynamically developed social networking group is based upon, at least in part, one or more attributes of a plurality of members of the social networking group.

4. The computer program product of claim 1, wherein the instructions for collecting information further including instructions for associating a confidentiality sensitivity level associated with the information regarding one or more attributes of the members of the social networking group.

5. The computer program product of claim 4, wherein the instructions for associating a confidentiality sensitivity level include instructions for associating the confidentiality sensitivity level based upon, at least in part, a user input.

6. The computer program product of claim 4, wherein the instructions for associating a confidentiality sensitivity level include instructions for associating the confidentiality sensitivity level based upon, at least in part, one or more predetermined schema.

7. The computer program product of claim 4, wherein the instructions for providing anonymized statistical data based upon the information include instructions for providing anonymized statistical data consistent with the confidentiality sensitivity level associated with the information.

8. A computing system comprising:
a processor;
a memory module;
a first software module executable by the processor and the memory module, wherein the first software module is configured to define a dynamically developed social networking group within a collaborative platform;
a second software module executable by the processor and the memory module, wherein the second software module is configured to collect information regarding one or more attributes of one or more members of the group; and
a third software module executable by the processor and the memory module, wherein the third software module is configured to provide anonymized statistical data regarding the group, based upon, at least in part, the information regarding one or more attributes of one or more members of the group.

9. The computing system of claim 8, wherein the dynamically developed social networking group is based upon, at least in part, one or more formal organization charts.

10. The computing system of claim 8, wherein the dynamically developed social networking group is based upon, at least in part, one or more attributes of a plurality of members of the social networking group.

11. The computing system of claim 8, wherein the second software module, configured to collect information, is further configured to associate a confidentiality sensitivity level associated with the information regarding one or more attributes of the members of the social networking group.

12. The computing system of claim 11, wherein the second software module, configured to associate a confidentiality sensitivity level, is further configured to associate the confidentiality sensitivity level based upon, at least in part, a user input.

13. The computing system of claim 11, wherein the second software module, configured to associate a confidentiality sensitivity level, is further configured to associate the confidentiality sensitivity level based upon, at least in part, one or more predetermined schema.

14. The computing system of claim 11, wherein the third software module, configured to provide anonymized statistical data based upon the information, is configured to provide anonymized statistical data consistent with the confidentiality sensitivity level associated with the information.

15. A computer implemented method comprising:
defining a dynamically developed social networking group within a collaborative platform;
collecting information regarding one or more attributes of one or more members of the group;
storing the information regarding one or more attributes of one or more members of the group on a storage device coupled to a computing device; and
providing anonymized statistical data regarding the group, based upon, at least in part, the information regarding one or more attributes of one or more members of the group.

16. The computer implemented method of claim 15, wherein the dynamically developed social networking group is based upon, at least in part, one or more formal organization charts.

17. The computer implemented method of claim 15, wherein the dynamically developed social networking group is based upon, at least in part, one or more attributes of a plurality of members of the social networking group.

18. The computer implemented method of claim 15, wherein collecting information further includes associating a confidentiality sensitivity level associated with the information regarding one or more attributes of the members of the social networking group.

19. The computer implemented method of claim 18, wherein associating a confidentiality sensitivity level includes associating the confidentiality sensitivity level based upon, at least in part, a user input.

20. The computer implemented method of claim 18, wherein associating a confidentiality sensitivity level includes associating the confidentiality sensitivity level based upon, at least in part, one or more predetermined schema.
